(19) United States
(12) Patent Application Publication
(10) Pub. No.: US 2004/0235459 A1
(43) Pub. Date: Nov. 25, 2004

(54) Systems and methods for generating a feature list indicating the activated features of a mobile station

(75) Inventor: Esa Juntunen, Irving, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 10/444,484

(22) Filed: May 23, 2003

(51) Int. Cl. H04M 3/42

(52) U.S. Cl. 455/414.1; 455/550.1

(57) ABSTRACT

The present invention provides systems and methods that generate a feature list indicating the various features available in a mobile station and which of the features are enabled. The feature list can be displayed to the user and/or transmitted to remote customer service personnel. The feature list can be used to determine what features are activated on the mobile station for purposes of troubleshooting. Further, since the feature list is specific to each mobile station, a common operation manual for a plurality of different mobile stations can be used, where the user is directed by the manual to consult the feature list of the mobile station to determine whether a feature is available. Further, the feature list allows a service provider to determine what features are available on each end customer's mobile station and target marketing based on this information.

### BACKGROUND OF THE INVENTION

1. Field of the Invention

The present invention relates to determining and indicating the various features available and their status as enabled or disabled in a mobile station, such as a cell phone.

2. Description of Related Art

In recent years, there has been a marked increase in the number of features that are available on mobile stations, such as cell phones. This increase has been facilitated in part by the advancement in the electronics and battery packs used in the stations. Further, as users have become more accustomed to the use of mobile stations, such as cell phones, users have requested the addition of features to the mobile stations to thereby increase their versatility. In fact, the various features provided by a particular mobile station, such as a cell phone, is a major factor considered by many end consumers when buying a new cell phone and/or selecting a service provider.

The rapid addition of new features to cell phones and other mobile stations has caused some logistical issues for manufactures and service providers, however. Specifically, in some instances, new features are added to cell phones during manufacture. As the operating manuals associated with the phones are supposed to reflect the various features offered by a cell phone, it is difficult and time consuming to update manuals to reflect these additions and changes. For example, in the early stage of production, a particular cell phone model may not be slated to include a particular feature, but some time later it may be decided to add this feature to the cell phone during manufacture. In these instances, the operation manuals associated with the cell phones will need updating prior to shipment of the phones. If there have been previous cell phones shipped without the feature, the manufacturer will also have to maintain two versions of the operation manual.

Another issue involves the individualized services offered by each service provider. Although more than one service provider may offer the same phone to their customers, some service providers may support only certain features available on the cell phone, and/or may require an added fee to support some services. In these instances, the cell phones supplied for each service provider by the manufacturer will typically have the same features, but will have those features not supported by the particular service provider disabled. Here again, this causes issues with regard to operation manuals.

It would not be considered good business practice to provide a generic operation manual to all end customers listing all features of the phones, when some of the features are not supported by the end customer's service provider. As such, many cell phone manufacturers currently provide different operation manuals for each series of phone depending on the specific features activated in the cell phone.

Further, after a cell phone or other mobile station has been delivered to an end customer, the service provider may decide to begin offering a feature of the cell phone that was previously disabled and/or the end customer may decide to pay an added fee for an additional feature. This raises several issues. First, there currently does not exist an easy way for an end customer to determine what features are available on their cell phone, as their operation manual may only list the activated features and not all possible features of the phone. Typically, the end customer must present his/her cell phone to a service provider representative. The service provider would then, in turn, have to search records associated with the model of the cell phone, date of manufacturer, etc. to determine what possible features were included in the cell phone. In addition, after the end customer's phone has been reconfigured by turning on added features, the operation manual sent originally with the cell phone may be outdated, as it did not include information about these newly added features.

In light of the above, systems and methods are needed that will allow a cell phone manufacturer, service provider, and/or end customer to quickly determine what features are available on a given cell phone or other mobile station and possibly what features the cell phone that are not currently activated. Further, it would be advantageous to provide a system that would allow the manufacturer to more easily manage administration of operation manuals.

### BRIEF SUMMARY OF THE INVENTION

The present invention provides systems and methods that overcome the above-listed, as well as many other disadvantages related to alteration of the features provided by a mobile station such as a cell phone. Specifically, the present invention provides systems and methods for creating a feature list for a given mobile station that indicates at least the activated features of the mobile station and possibly the status of all features of the mobile station. The systems and methods of the present invention include a routine that when activated searches the various flags and other indications stored in the software of the mobile station. Based on these flags, the systems and methods of the present invention generate the feature lists. In some embodiments, the feature list only includes those features that are activated, while in other embodiments, the feature list may include a listing of all available features with an indication as to which features are currently activated.

In some embodiments, the feature list is not stored. Instead, a new feature list is generated each time the routine is initiated. This, in turn, ensures that the feature list represents the most recent settings of the cell phone or other mobile station.

The feature list generated by the systems and methods of the present invention provides several advantages to the manufacturer, service provider, and end customer. For example, the generated feature list allows the manufacturer to determine at the end of manufacturer what features are activated on a particular mobile station for quality control and for ensuring that a mobile station with the proper features is being shipped to the proper service provider. Further, the manufacturer can download and store the feature list for each cell phone as a historical record for the mobile station.

Importantly, the feature list generated by the systems and methods of the present invention allows a manufacturer to reduce cost and confusion associated with operation manuals. Instead of maintaining different versions of a manual for each mobile station based on the features activated in the mobile station, the manufacturer can use one generic manual that lists all possible features of the mobile station. In this instance, the manual would not positively state that a particular mobile station has the feature. Instead, the manual would describe the feature and instruct the end customer to review the feature list associated with the end customer's mobile station to determine whether the feature is activated and/or available for activation.

With regard to the end customer, in some embodiments, the end customer may be provided with access to the feature list generated by the systems and methods of the present invention. This will allow the end customer to determine what features are activated and/or what features are available without requiring the end customer to contact his/her service provider or the manufacturer.

The feature list generated by the systems and methods of the present invention is also a major benefit to the service provider. As an initial point, the feature list facilitates better and more reliable customer service. Specifically, when an end customer has an issue with their mobile station related to features, the service provider can either connect to the mobile station remotely and request that the mobile station transmit the feature list to the service provider or the service provider can ask the end customer to read out the contents of the feature list, thus reducing the number of instances where the end customer is required to visit the service provider's service center.

Additionally, many of the features of a cell phone can be activated remotely. Thus, after the service provider has reviewed the feature list for the mobile station, the service provider may be able to activate, reset, or deactivate a feature remotely. After this operation is complete, the service provider can then request a new feature list to determine whether the changes were made.

As mentioned previously, the service provider may not support all available features of a particular mobile station, and/or the service provider may charge an added premium for some features. The feature list generated by the systems and methods of the present invention provides an added method for the service provider to either upgrade the features offered or market the additional features to potential end customers currently not subscribing to the added features. Specifically, in embodiment, the systems and methods of the present invention allow a service provider to retrieve a feature list from either one or a plurality of mobile stations. The systems and methods of the present invention can then be used to determine which mobile stations can support a selected feature, but do not have the feature activated. Using this information, the service provider could remotely activate the feature on the mobile stations, if the feature is to be provided free of charge, and/or the service provider could market the added feature to the end customer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of a mobile communications system according to one embodiment of the present invention including a mobile station and a Base Station/MSC/Interworking function (BMI) to which the mobile station is bidirectionally coupled through wireless RF links;

FIG. 2 is a schematic diagram of a mobile station according to one embodiment of the present invention;

FIG. 3 is an operation diagram illustrating a method for generating a feature list for a mobile station according to one embodiment of the present invention; and

FIG. 4 is an operational diagram illustrating a method for determining whether an end customer wishes to activate a feature on their mobile station according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

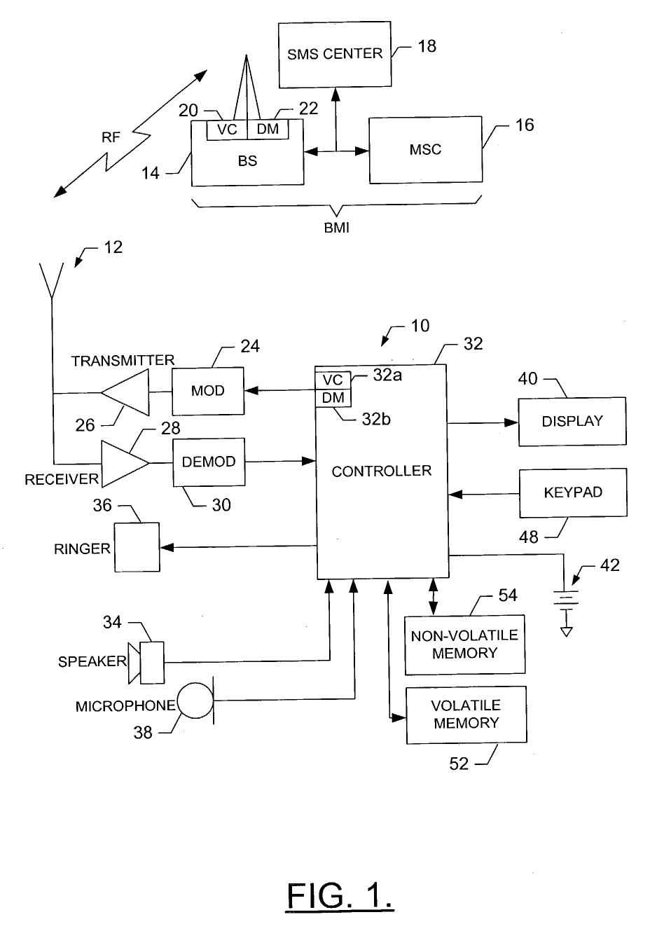

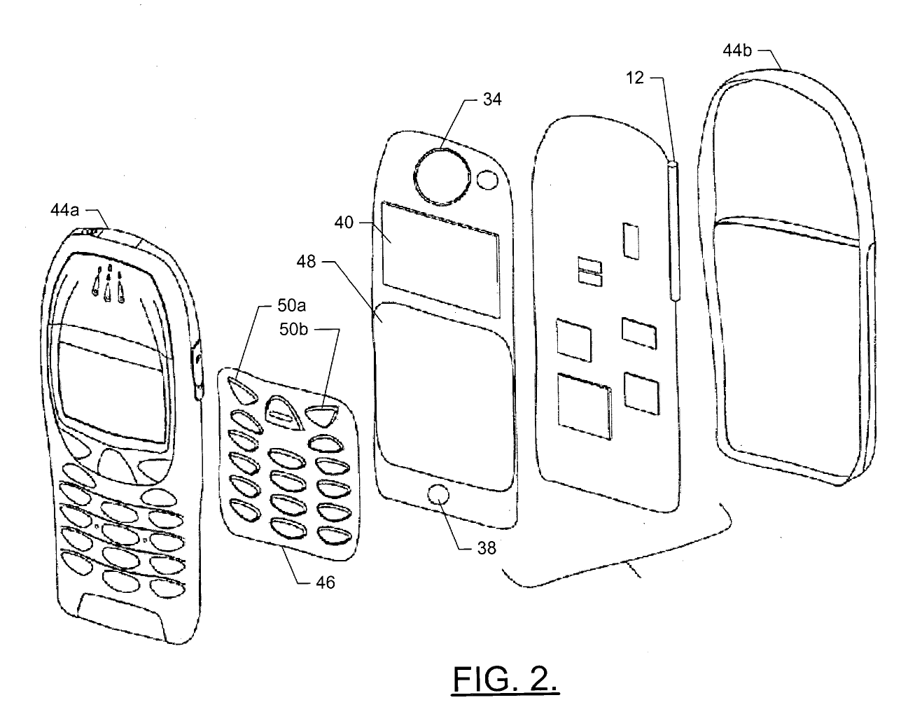

FIGS. 1 and 2 are respective schematic and perspective diagrams illustrating the generic features of a typical mobile station. In this particular instance, FIGS. 1 and 2 illustrate a cell phone, which is just one example of the different types of mobile stations in which the systems and methods of the present invention could be implemented. It must be understood that although the systems and methods of the present invention are described below in the context of a typical cell phone, that the present invention is not limited to either a particular type of cell phone or a particular type of mobile station. In a broad sense and as is contemplated herein, the systems and methods of the present can be used in any mobile station containing various features that may or may not be activated.

Referring to FIGS. 1 and 2, a typical mobile station 10 includes an antenna 12 for transmitting signals to and for receiving signals from a base site or base station (BS) 14. The base station is a part of a cellular network that includes a mobile switching center (MSC) 16, an SMS center 18, voice coder/decoders (vocoders) (VC) 20, data modems (DM) 22, and other units required to operate the network. The MSC is capable of routing calls and messages to and from the mobile station when the mobile station is making and receiving calls. The MSC also provides a connection to landline trunks when the mobile station is involved in a call. As indicated above, the cellular network may also be referred to as a Base Station/MSC/Interworking function (BMI) 14.

To communicate with the BMI 14, the mobile station 10 includes a modulator (MOD) 24, a transmitter 26, a receiver 28, a demodulator (DEMOD) 30, and a controller 32 that provide signals to and receive signals from the transmitter and receiver, respectively. These signals include signaling information in accordance with the communications standard of the applicable communication system, and also user speech and/or user generated data. For example, in the case of cell phones, the communications standard can comprise the Global System for Mobile (GSM) communications standard, the Code Division Multiple Access (CDMA) communications standard or any of their progeny and the like. The mobile station may also be configured to meet the wireless application protocol (WAP) specification. The controller 32 includes the circuitry required for implementing the audio and logic functions of the mobile station. The controller also includes the functionality to convolutionally encode and interleave message and data prior to modulation and transmission. The controller can additionally include an internal voice coder (VC) 32A, and may include an internal data modem (DM) 32B.

The mobile station 10 also comprises a user interface that includes a conventional earphone or speaker 34, a ringer 36, a conventional microphone 38, a display 40, and a user input interface, all of which are coupled to the controller 32. The mobile station also includes a battery 42 for powering the various circuits that are required to operate the mobile station.

To store data upon receipt from the various sources, the mobile station includes volatile memory 52, such as volatile Random Access Memory (RAM) including a cache area for the temporary storage of data. The mobile station can also include non-volatile memory 54, which can be embedded and/or may be removable such as a removable Subscriber Identification Module (SIM). The memories are used to store various pieces of information, such as settings for the various features of the mobile station, telephone numbers, calendar dates, emails, pictures, etc. The memories also include computer program products that control the operation of all or a portion of the controller 32 to thereby implement the present invention. The controller, which can include embedded cache memory, generates appropriate commands and controls the other component blocks of the mobile station.

As illustrated in FIG. 2, the mobile station includes an external housing 44 that encapsulates the electronics of the mobile station. The mobile station also includes a user input membrane, such as a keypad membrane 46 that interfaces with a keypad 48, which collectively allow the mobile station to receive data from a user. The user membrane includes the conventional numeric (0-9) and related keys (#, *), and other keys used for operating the mobile station. In addition to the soft keys 50A and 50B, the other keys may include, for example, a SEND key, various menu scrolling keys and a PWR key. The display 40 can present any of a number of different displays, such as data, menus and/or listings. The display can also display areas for soft key functions that can be activated by pressing soft keys 50A and 50B located on a user input interface.

As stated, the mobile station includes software that is loaded in the memory of the mobile station and operated on by the controller 32. The software dictates the various operations of the mobile station. Further, and importantly, the software, in conjunction with the hardware, provide various features of the mobile station that control the basic functions of mobile station and/or provide enhanced services. Many of the basic functions available in cell phones, for example, are features related to placement and reception of phone call, telephone number storage, caller ID, etc. There are other features of the cell phone that are not as readily apparent, and/or have been added more recently to cell phones, such as voice dialing, picture messaging, etc. There are also features of the phone related to communication features such as wireless application protocol (WAP) and general radio packet service (GPRS).

As discussed above, most conventional mobile stations, such as cell phones, do not provide a convenient way of determining what the available features on the mobile station are and which ones of the features are activated. In light of this, the present invention provides systems and methods that create a feature list listing either all features of the mobile station with an indication of which features are activated or listing only the activated features. This, in turn, allows the manufacturer, service provider, and end customer to conveniently determine what features are available and what features are currently activated on a given mobile station.

With reference to FIG. 1, the systems and methods of the present invention provide a computer readable program code, (i.e., software), typically in the form of a module or modules in the operating software stored in the memory of the mobile station 10 and operated on by the controller 32. The software module, when activated, searches through the various stored databases and registers of the mobile station and evaluates the various flags or other notations with regard to the various features of the mobile station. The module determines from this evaluation what features are available in the mobile station and what features are activated. The module then creates a feature list that can either be displayed on the mobile station and/or transmitted to another device for evaluation. In general, the feature list is not saved in the mobile station, but is typically generated anew each time to ensure that the most up to date information is provided. The feature list can, however, be saved and updated upon request.

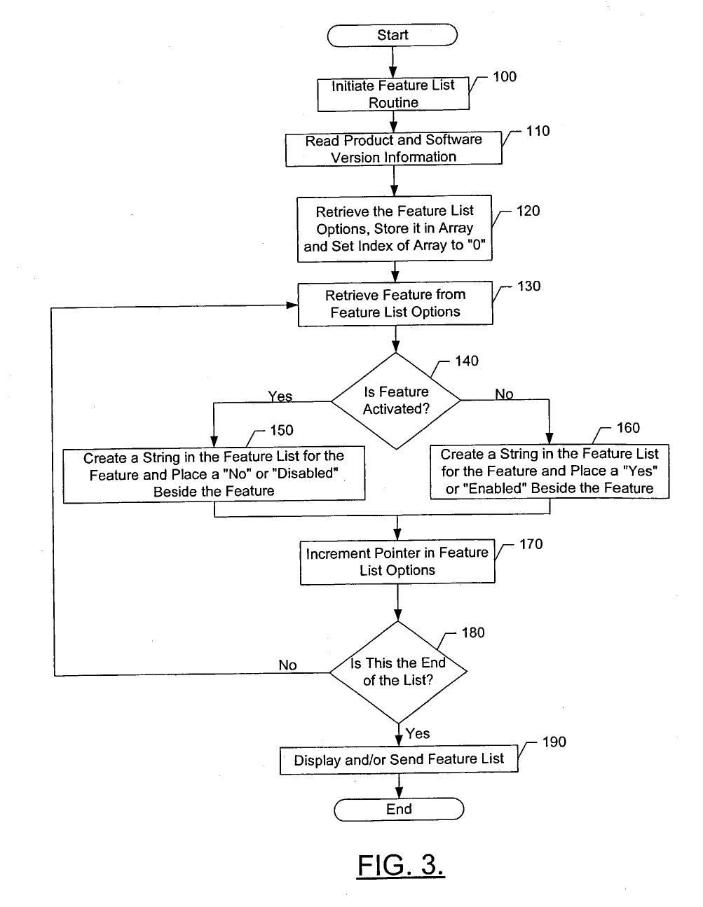

FIG. 3 provides an illustrative embodiment of the operations performed by the systems and methods of the present invention. Specifically, the systems and methods are initiated either by providing an input from the keypad 48 of the mobile station such as entering for example “#feat#” or by transmitting a signal to the mobile station from the service provider. (See block 100 ). Upon reception of a feature list command, the systems and methods of the present invention first accesses data storage containing the product information related to the phone. (See block 110 ). This information typically includes the manufacturer and model information related to the mobile station, the version of the software used, the frequency band in which the mobile station operates, etc.

Next, the systems and methods of the present invention retrieve a “features list options” that is stored in memory in a data structure, such as an array, file, etc. (See block 120). The “features list options” is compiled at the time the software for the mobile station is created. It defines what parameters are to be included in the feature list. Typically, the “features list options” includes all features of the mobile station with an indication of which features are to be included in the feature list. Along, with each feature, the “features list options” may include a pointer indicating where in the data storage the flag is located that designates whether the feature is enabled or disabled. An example of a portion of the features of a “features option list” is illustrated below:

| | |
|---|---|
| *FEAT_VOICE_DIALING = TRUE | ; voice dialing |
| *FEAT_PICTURE_MESSAGING = TRUE | ; picture messaging |
| *FEAT_EOTD = TRUE | ; Enhanced Observed Time |
| | Difference |
| *FEAT_AMR = TRUE | ; Adaptive Multi Rate |
| *FEAT_SHOW_DIALUP = TRUE | ; show dialed number, |
| *FEAT_CSP = TRUE | ; Customer Service Profile |
| *FEAT_EDGE = FALSE | ; Enhanced Data rates for |
| | Global Evolution |

As illustrated, items marked as TRUE would be included in the feature list report, while items marked as FALSE would not be investigated by the systems and methods of the present invention.

It must be noted here that an existing “features list options” is not required for operation of the present invention. Specifically, the “features list options” could be generated by the systems and methods of the present invention as part of the features list generation. In this embodiment, the system and methods would search through the data storage and determine what features are available for the mobile station and generate the “features list” on the fly.

With regard to FIG. 3, the systems and methods of the present invention access the “features list options” and store it into an array. They systems and methods set the index to the array to 0 in order to read out the first feature stored in the list. (See block 120).

Next, the systems and methods of the present invention read the feature from the list one at a time and access the proper storage locations to determine whether the feature is active or disabled. (See blocks 130 and 140). If the feature is activated, the systems and methods of the present invention place a proper indication beside the feature, such a “yes,” “enabled,” or “active.” (See block 150). Likewise, if the feature is disabled, the systems and methods place an indication beside the feature such as “no,” “disabled,” or “inactive.” (See block 160). The systems and methods of the present invention then increment the index of the “features options list” and determine whether a next feature is to be checked or whether the end of the list has been reached. (See blocks 170 and 180). The process is continued until all features in the “features options list” have been checked. The generated feature list is then displayed to the user of the mobile station or transmitted using the transmitter of the mobile station to the service provider for review or downloaded via IR or cable connection to the mobile station. (See block 190).

As an example, the following feature list could be generated. Note that the text description following the semicolons would not be displayed but are used herein to describe the various features listed.

| | | |
|---|---|---|
| Product: | NSM-9 | ; model and/or product no. for the |
| | | phone |
| SW version: | 40.55 | ; version of software in the phone |
| Freq. Band: | 850/1900 | ; frequency band used by phone |
| | GSM | |
| GPRS: | No | ; general radio packet service disabled |
| CSP: | Yes | ; Customer Service Profile enabled |
| Voice Dialing: | Yes | ; enabled |
| Picture Messaging: | Yes | ; enabled |
| EOTD: | No | ; Enhanced Observed Time |
| | | Difference disabled |
| AMR: | Yes | ; Adaptive Multi Rate enabled |
| Show Dial Up No. | Yes | ; enabled |
| Etc. | | |

As discussed, the systems and methods of the present invention include a features options list, generated features list, and typically a software routine for accessing each feature in the feature options list, determining whether the feature is enabled, and storing an indication in the generated features list. The two lists and routine are stored in the mobile station in data structures. Data structures may include arrays, data files, data registers, etc. Further, the feature options list and/or the routine may be stored at the time the mobile station is manufactured, or they may be transmitted to and stored in the mobile station, such as by a cable, infrared, RF, etc. They can also be updated by subsequent transmission and download. For example, for existing mobile stations in the market, the features options list and routine can be transmitted to and downloaded by the mobile station, thereby allowing the existing mobile station to be retrofitted with the systems and methods of the present invention.

As mentioned, the generation of the feature list provides various advantages to the manufacturer, service provider, and end customer. For example, the feature list can be generated after the mobile station has been manufactured and prior to shipment. The feature list could be used to ensure that the mobile station has been properly configured and/or archived for later use, such as for later maintenance on the mobile station. Further, because the feature list discloses all of the features available and/or active on the phone, the manufacturer does not have to provide different operation manuals for each version of the phone based on its specific enabled features. Instead, the manufacturer can provide an operation manual including all features available on a wide variety of phones, with a statement for the user to check the feature list on their mobile station to determine whether such feature is available.

The feature list is also valuable to the end customer, as it allows the end customer to quickly determine what features are activated in their mobile station and/or possibly what features the phone has that are not activated. This aids the end customer in understanding the operation manual more fully and troubleshooting issues prior to calling or visiting their service provider. For example, an end customer may note a feature of mobile stations similar to his/her's and may wonder whether their mobile station has this feature. The end customer could command the mobile station to generate the feature list so as to determine whether the feature is available on their mobile station.

In this scenario, the end customer may be able to activate a feature that is currently disabled through a series of commands to the phone. Specifically, the feature list generated by the systems and methods of the present invention may include embedded with each feature a procedure for activating or disabling a feature. Further, if the feature must be activated by a service provider, the feature list may include embedded information for the feature that indicates to the end customer that they should contact their service provider concerning changing the status of feature.

In particular, the end customer could select a feature of interest from the feature list. When the feature is selected a separate window could appear giving the end customer information about how to enable the feature or it may direct end customer to contact their service provider.

The feature list is also advantageous for sharing information between different end customers. For example, two end customers may wish to play a game on their individual phones that would be interactive between the two users, but only one of the end customers currently has the game downloaded on their mobile station. In this instance, the end customer could send his/her feature list to the other end customer using IR, email message, phone message, etc. The feature list will include a reference as to where the game can be downloaded. The other end customer would review the feature list and using the reference in the list, download the game for play. For example, the reference may be a link to a website where the game is located.

The feature list also facilitates better customer service between the end customer and the service provider when there are issues with the mobile station. Specifically, if the end customer is having problems with their mobile station or is curious about a feature of the mobile station, the feature list allows the end customer to get information about the phone without requiring him/her to visit the service provider.

For example, when the end customer calls the help center of the service provider, either the end customer or the service provider could command the mobile station to generate the feature list. In particular, the end customer could command the mobile station to generate the feature list and then either read the list to the service provider or command the mobile station to transmit the feature list to the service provider. Alternatively, the service provider could send a command to the mobile station requesting that it generate the feature list and transmit it to the service provider. Using the feature list, the service provider can troubleshoot and fix the problem. Provided below is an example dialogue of a customer service call between an end customer and a service provider to illustrate this aspect of the invention:

```
User calls to customer service and says: “My picture messaging doesn't
    work.
During the call, customer service asks the end customer to command the
    mobile station to generate a feature list by pressing for example
    “#feat#.”
End customer would then read the feature list or hit send to have it sent to
    customer service. (Alternatively, the customer service could send
    a command to the mobile station requesting that it generate the
    feature list and send it to the customer service
The feature list would indicate that the picture messaging is disabled
Customer service would as the end customer if he/she wishes to enable
    the service
If so, customer service will either enable it remotely, instruct the end
    customer on how to enable the feature, or request that the end
    customer visit a customer service center to activate the feature
After the feature is activated, the feature list could be regenerated to
    confirm that the process was properly performed.
```

In addition to providing enhanced customer service, the systems and methods of the present invention also allow a service provider to effectively market features of the mobile station that have either recently been added to the service or are features that require the end customer pay an added fee for the feature. For example, in a first instance, the service provider may have decided to support an added feature that is capable of being implemented in some of its end customer's mobile stations, or in another instance, the service provider may want to alert end customers of an upgrade feature that they can subscribe to for an added fee. In either case, it is advantageous for the service provider to determine what mobile stations support the feature and then how to market the feature to the end customers.

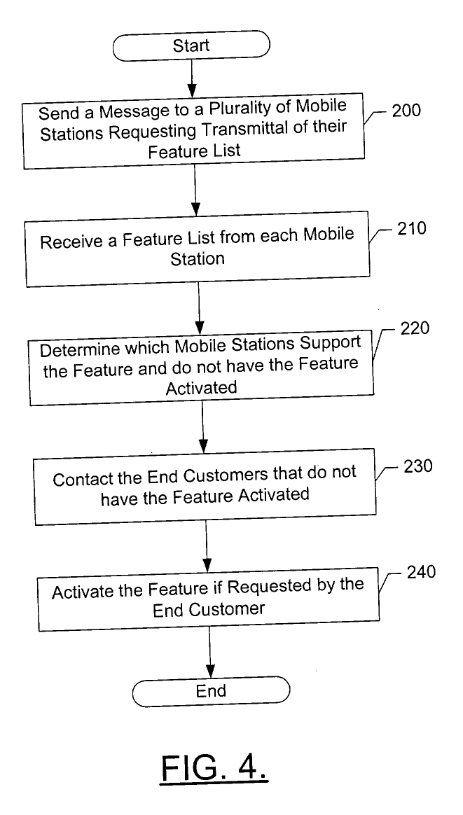

With reference to FIG. 4, in this scenario, the service provider could first send a polling message to the mobile stations of each of its customers. (See block 200). Based on the polling message, each mobile station will generate a feature list and report either the entire list or the feature in question to the service provider, along with the ID of the mobile station. (See block 210). The service provider can then determine which of the mobile stations is capable of supporting the feature and which mobile stations currently do not have the feature activated. (See block 220). The service provider could then contact those end customers whose mobile stations support the feature but have it disabled. (See block 230). This could be via an automated message, email, mailing, etc. If the end customer is interested in the feature, the service provider could either instruct the end customer how to enable the feature or the service provider could enable the feature remotely or by having the end customer visit a customer service center. (See block 240). Note, that if the feature is an upgrade and does not require an added fee, the service provider could activate the feature and send a message to the end customer concerning the enhancement made to their services.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for determining the features supported by a mobile station comprising:
a first data structure comprising each feature supported by the mobile station and a location in a data storage device of the mobile station where the information related to the feature is stored;
a second data structure; and
a routine stored in a computer readable medium, wherein said routine, for at least one feature in said first data structure, accesses the location of the data storage device containing information related to the feature and determines whether the feature is enabled, and stores in the second data structure a representation of the feature and an indication of whether the feature is enabled.

2. A system according to claim 1, wherein said first and second data structures are the same data structure, and for the at least one feature, said routine stores in said first data structure an indication of whether the feature is enabled.

3. A system according to claim 1, wherein at least one of the first and second data structures is a file stored in a computer readable medium.

4. A system according to claim 1, wherein said routine displays the contents of said second data structure on a display of the mobile station.

5. A system according to claim 1, wherein said routine transmits the contents of said second data structure to a remote location.

6. A system according to claim 1, wherein said second data structure comprises a subset of the features listed in said first data structure.

7. A system according to claim 1, wherein said routine rewrites the contents of the second data structure each time said routine is initiated.

8. A system according to claim 1, wherein said routine includes information for at least one feature in said second data structure instructing a user on how to enable the feature.

9. A system according to claim 1, wherein the contents of said first data structure are transmitted to the mobile station by a wireless transmission and downloaded into said first data structure.

10. A system according to claim 1, wherein said routine is transmitted to the mobile station by a wireless transmission and downloaded into the computer readable medium.

11. A method for determining the features supported by a mobile station comprising:
providing a first data structure, where the first data structure comprising each feature supported by the mobile station and a location in a data storage device of the mobile station where information related to the feature is stored;
providing a second data structure;
for at least one feature in the first data structure, accessing the location of the data storage device containing information related to the feature;
determining whether the feature is enabled; and
storing in the second data structure a representation of the feature and an indication of whether the feature is enabled.

12. A method according to claim 11, wherein the first and second data structures are the same data structure and for the at least one feature said storing step stores in the first data structure an indication of whether the feature is enabled.

13. A method according to claim 11, wherein at least one of the first and second data structures is a file stored in a computer readable medium.

14. A method according to claim 11 further comprising displaying the contents of the second data structure on a display of the mobile station.

15. A method according to claim 11, further comprising transmitting the contents of the second data structure to a remote location.

16. A method according to claim 11, wherein said storing in a second data structure step comprises storing a subset of the features listed in said first data structure.

17. A method according to claim 11, wherein said storing in a second data structure comprises rewriting the contents of the second data structure each time said method is initiated.

18. A method according to claim 11, wherein said storing in a second data structure comprises storing information for at least one feature in the second data structure instructing a user on how to enable the feature.

19. A method according to claim 11 further comprising:
transmitting the contents of said first data structure to the mobile station by a wireless transmission: and
downloading the contents into the first data structure.

20. A method according to claim 11 further comprising:
transmitting a command to a plurality of mobile stations requesting that each mobile station generate a list of the features enabled on the mobile station;
receiving the list from each mobile station;
for a given feature, determining which mobile stations have the feature disabled; and
contacting an end user associated with those mobile stations having the feature disabled.

21. A method according to claim 20 further comprising enabling the previously disabled feature on the mobile station.
